(19) United States
(12) Patent Application Publication
(10) Pub. No.: US 2015/0046482 A1
(43) Pub. Date: Feb. 12, 2015

(54) TWO-LEVEL CHUNKING FOR DATA ANALYTICS

(71) Applicants: Lei Wang, Beijing (CN); Jun Yang, Chapel Hill, NC (US); Jiaqi Yan, Harbin, Heilongjiang (CN); Min Wang, Cortlandt Manor, NY (US)

(72) Inventors: Lei Wang, Beijing (CN); Jun Yang, Chapel Hill, NC (US); Jiaqi Yan, Harbin, Heilongjiang (CN); Min Wang, Cortlandt Manor, NY (US)

(21) Appl. No.: 14/384,576

(22) PCT Filed: Mar. 15, 2012
(86) PCT No.: PCT/US12/29275

§ 371 Date: Sep. 11, 2014

(51) Int. Cl. G06F 17/30; G06F 17/16

(52) U.S. Cl. CPC G06F 17/30336; G06F 17/16
USPC 707/756

(57) ABSTRACT

Two-level chunking for data analytics is disclosed. An example method includes dividing an array into fixed-size chunks. The method also includes dynamically combining the fixed-size chunks into a super-chunk, wherein a size of the super-chunk is based on parameters of a subsequent operation.

### BACKGROUND

Large amounts of multidimensional data are generated by large-scale scientific experiments, such as but not limited to astronomy, physics, remote sensing, oceanography and biology. The volume of data in these fields is approximately doubling each year. These large volumes of scientific data are often stored in databases, and need to be analyzed for decision making. The core of analysis in scientific databases is the management of multidimensional arrays. A typical approach is to break the arrays into sub-arrays. These sub-arrays are constructed using different strategies, which include but are not limited to defining the size of sub-arrays. Defining sub-array size impacts the performance of I/O access and operator execution. Existing strategy uses predefined and fixed size sub-arrays, which make it difficult to satisfy the different input parameters for different analysis applications.

### BRIEF DESCRIPTION OF THE DRAWINGS

FIG. 1 is a diagram illustrating example chunk-oriented storage.

FIG. 2 is a diagram illustrating an example two-level chunking schema.

FIG. 3 is a diagram illustrating an example execution plan using a two-level chunking schema.

FIG. 3a is a diagram illustrating an example of matrix multiplication using a two-level chunking schema.

FIG. 4 is a plot showing OR factorization with various width super-chunks.

FIG. 5 is a flowchart illustrating example operations which may be implemented as two-level chunking for data analytics.

### DETAILED DESCRIPTION

Scientific activities generate data at unprecedented scale and rate. Massive-scale, multidimensional array management is an important topic to the database community.

Structured Query Language (SQL) is a programming language designed for managing data in database management systems (DBMS), But SQL is awkward at expressing complex operations for query processing, such as for BLAS (Basic Linear Algebra Subprograms) which is widely used in statistical computing. Some scientific databases support a declarative query language extending SQL-92 with operations on arrays and provide a C++/JAVA® programming interface. Others define new languages.

Some applications extract data from the database into desktop software packages, such as the statistical package Matlab®, or using custom code (e.g., programmed in the JAVA® or C programming languages). But these cause copy-out overhead and out-of-core problems. For example, the applications run slowly or even crash when the size of data exceeds the size of physical main memory.

The query language (e.g., SQL) remains the programming language of choice, because the database engine enables users to push computations closer to physical data by creating user-defined functions (UDFs) and reduces overhead caused by high-volume data movement. The query language typically handles database processing of lame amounts of data as arrays.

Arrays are commonly represented in relational database management systems (DBMS) as tables. For example, an array A may be represented as a table A(I, J, . . . K, Value), where I, J, . . . K are attributes of the array A referred to as indices or dimensions. This approach works well in practice for very sparse arrays (i.e., arrays containing empty values), because the elements with empty values are typically not stored, But for dense arrays (i.e., arrays containing more data and fewer empty values), the indices occupy “expensive” space in terms of processing. For massive-scale datasets, the query processing of such tables is inefficient.

Using a pipeline execution model, the database engine calls get-next( ) to get an element from the array, and then determines a result. With object-relational applications, many database engines use simple array data types or provide APIs for the user to define custom data types. One approach is to break an array into several sub-arrays. This can significantly improve the overall performance of the database engine. But the size of the sub-array impacts the performance of data access (e.g., incurring input/output (I/O) overhead), and operator execution (e.g., incurring processor overhead).

Two-level chunking for data analytics is described herein. In a two-level chunking approach, an array is divided into a series of basic chunks. These basic chunks can be stored in physical blocks of memory. The chunks can be dynamically combined into a bigger super-chunk. The super-chunk can then be used in various operations.

Before continuing, it is noted that as used herein, the terms “includes” and “including” mean, but is not limited to, “includes” or “including” and “includes at least” or “including at least.” The term “based on” means “based on” and “based at least in part on.”

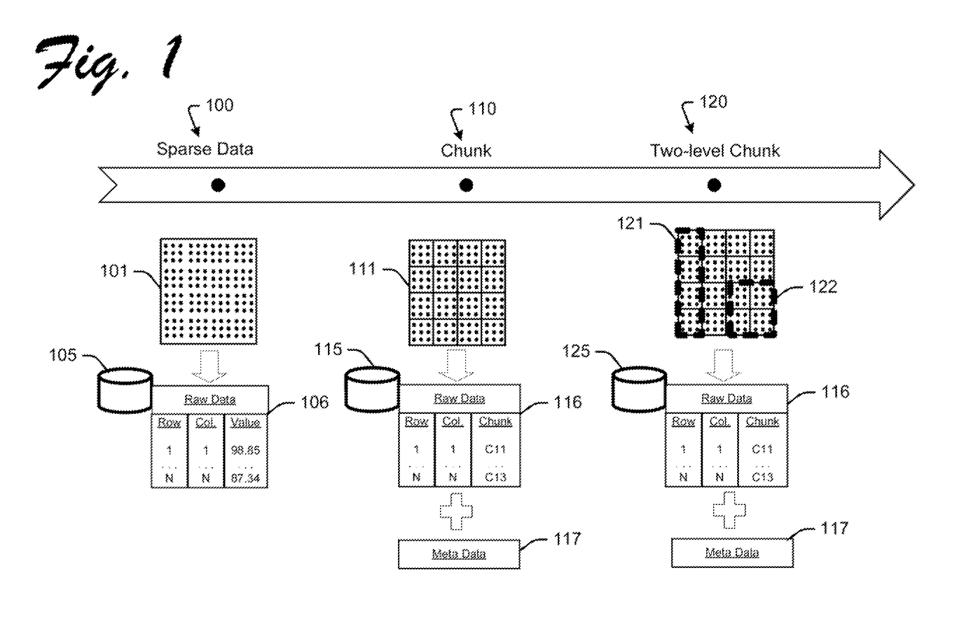

FIG. 1 is a diagram illustrating example chunk-oriented storage. Sparse data 100 is shown as it may be represented diagrammatically as a data structure or multi-dimensional array 101, wherein each dot in the array 101 represents a database element. The array 101 may be represented in the database 105 as a table 106 including row and column (col.) coordinates, and the corresponding data value at each coordinate. The array may be sub-divided into chunks 110, as illustrated by array 111. The array 111 may be represented in the database 115 as a table 116 including row and column (col.) coordinates, and the corresponding chunk value for each chunk coordinate and associated meta data 117.

For each chunk, many data storage layout strategies can be leveraged to convert an n-dimensional (n-D) array into single dimensional (1-D) array, such as row-major, column-major, s-order, and z-order. In databases, a chunk can be constructed and stored in two tables which record raw data 116 and metadata 117 separately. For example, for a single disk block, a chunk can be packed into a space that is several kilobytes (KBs) in size to several hundred megabytes (MBs) in size. The metadata table 117 records the structure information, such as number of dimensions, number of chunks in each dimension.

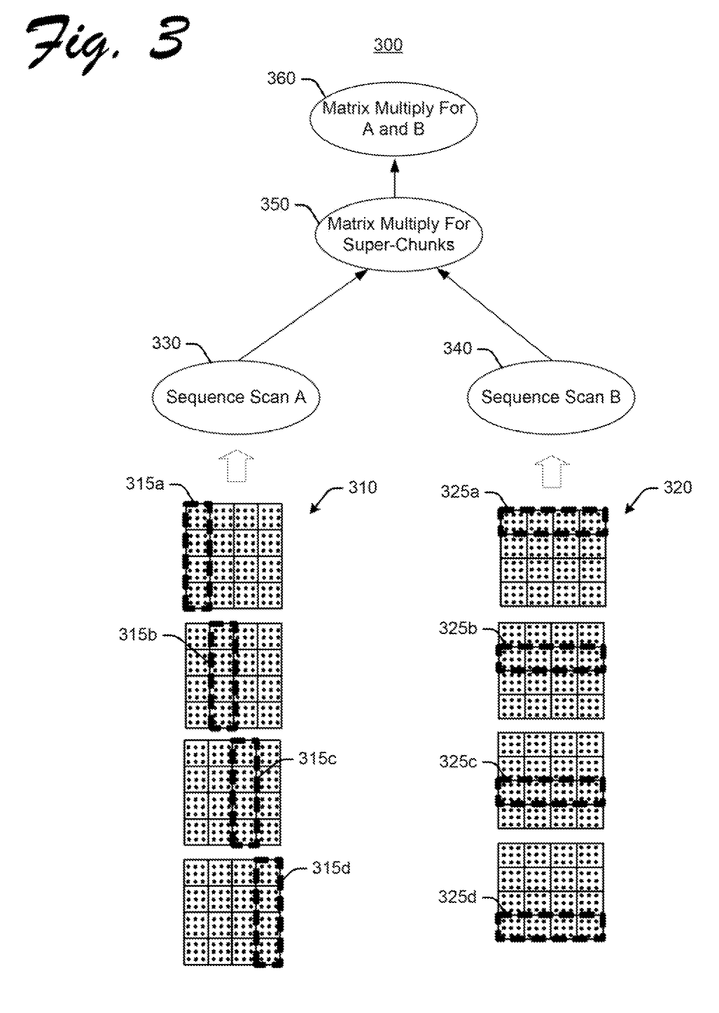

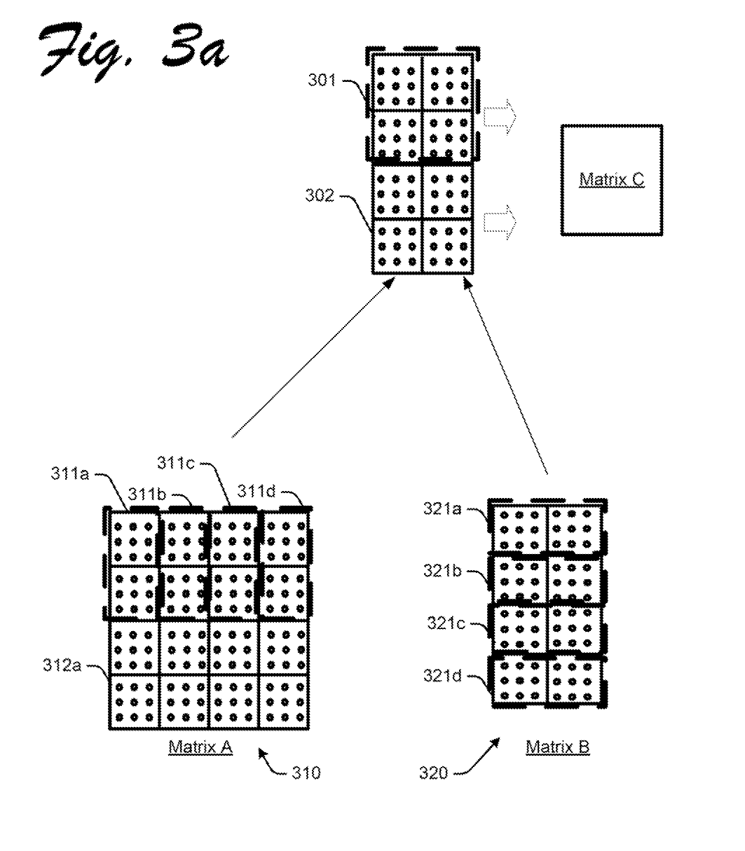

Two types of chunking strategies may be used, including regular (REG) and irregular (IREG) chunking. Using REG chunking, an array is broken into uniform chunks of the same size and shape. For example, an array may be constructed as a Matrix A_{m,n} where m=[1:12] and n=[1:12], as shown in FIG. 3, Using IREG chunking, an array is divided into chunks of the same amount of data without regard to the shape.

A similar approach may be used to define super-chunks. An example two-level chunk is illustrated in FIG. 1 at 120, which is shown over the underlying data structure 111, and includes super-chunk 121 and chunk 122. Again, the array 121 may be represented in the database 125 as a table 126 including row and column (col.) coordinates, and the corresponding chunk value for each chunk coordinate and associated meta data 127.

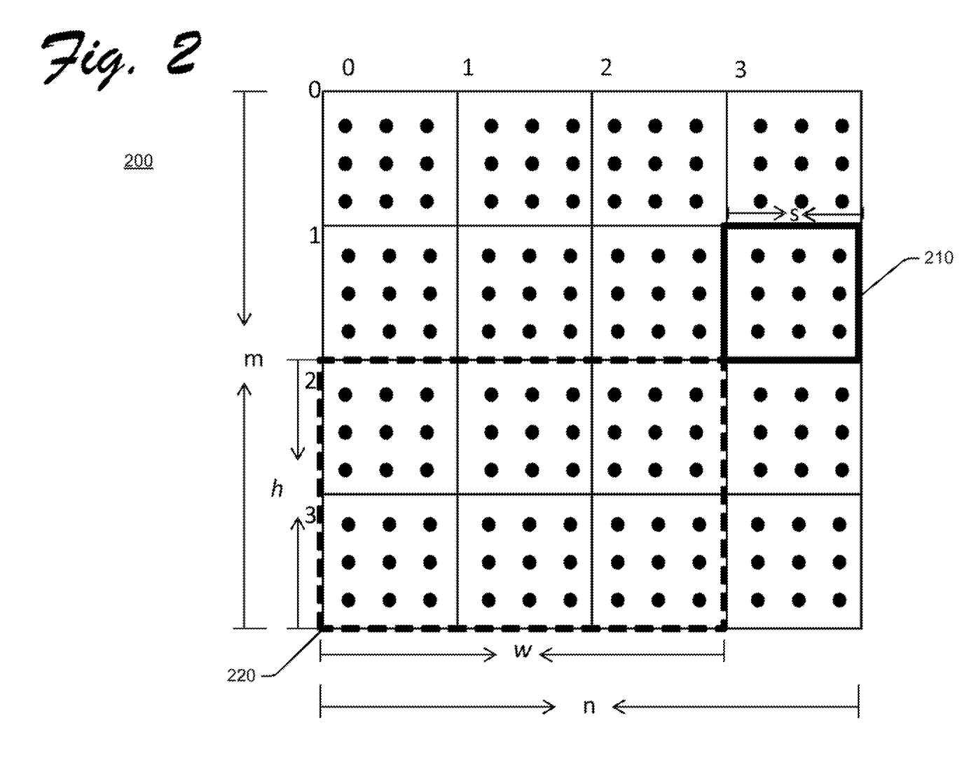

FIG. 2 is a diagram illustrating an example two-level chunking schema. In this example, a matrix 200 can be broken into sixteen regular chunks (e.g., 210) by splitting row and column dimensions into four and four respectively. The chunk size is fixed and regular. For example, the size of each chunk shown in FIG. 2 is 3×3. The chunk size is not limited to 3×3, just so long as the shape is the same.

Each chunk in the matrix 200 is “packed” with the same shape (represented by the dots in FIG. 3) without regard to the amount of data therein. As such, the chunks are suitable for use with dense data. For matrix multiplication, the chunks are construed to different super-chunks. For example, the data may be dynamically construed to column-oriented super-chunks (315a-d in FIG. 3) and row-oriented super-chunks (325a-d in FIG. 3) in matrix A and matrix B, respectively.

Two-level chunking may be implemented using single-level storage for n-dimensional (n-D) array management. In general, small chunks are generally more efficient for simple operations, such as selection queries and dicing queries. To fit the size of one physical block, the chunk may be constructed as 16K or 32K, meaning that only one I/O operation is executed to access each chunk. Larger chunks are generally more efficient for complex operations, such as matrix multiplication.

In first-level chunking, an array is divided into regular and fixed-size chunks (e,g., to form the underlying structure 200 having a height (m) and a width (n)). In second-level chunking, a dynamic schema is implemented on the top of the basic chunks in the underlying structure 200. The location of chunk 210 in the underlying structure 200 is a=1 and b=3. The location of super-chunk 220 is at s_a=2 and s_b=0.

The super-chunk 220 is used as the basic computing unit for database operations. The size and/or shape of the super-chunk 220 can be defined (e.g., by the user) according to the complexity of operator. For example, the height (h) and width (w) of the super chunk 220 may be defined based on the specific operator.

A range-selection query may be used to construct the super-chunk 320 by dynamically combining fixed-size chunks into a larger assembly. At run time, the operator combines the super-chunk 220 from different matrices. The basic chunks can be combined into a super-chunk 220 at runtime without changing the underlying storage structure. This chunking strategy can be used to achieve an optimum balance between I/O overhead and processor overhead.

For purposes of illustration, the two-level chunking strategy can be better understood as it may be applied to matrix multiplication (although the two-level chunking described herein is not limited to such an example). Matrix multiplication is widely used in statistical computing. For purposes of this illustration, matrix C is the product of matrix A and matrix B. That is, C [m,l]=A [m,n] B [n,l], where the parameters m and n of matrix A are illustrated in FIG. 2. The corresponding parameters n and I of matrix B are similar and therefore not shown in the figure.

The height and width of the super-chunk used in Matrix A is given by (h) and (w), respectively. The height and width of the super-chunk used in Matrix

B is given by (w) and (h), respectively. The size of each dimension of the basic chunk is given by (s).

Pseudo code for implementing two-level chunks for matrix multiplication may be expressed by the following Algorithm 1.

Algorithm 1: Matrix multiplication over two-level chunks

| | |
|---|---|
| 1: | input: Matrix A and Matrix B |
| 2: | output: Matrix C |
| 3: | for (int i = 0; i < m/(s*h); i = i++){ |
| 4: | for (int j = 0; j < l/(s*h); j = j++){ |
| 5: | init super-chunk S_C_{i,j}; |
| 6: | for (int k=0;k < n/(s*w); k<n++){ |
| 7: | super-chunk S_A_{i,k} = Rang_query(i,k,h,w); |
| 8: | super-chunk S_B_{k,j} = Rang_query(k,j,w,h); |
| 9: | S_C_{i,j} = S_C_{i,j} + S_A_{i,k} S_B_{k,j}; |
| 10: | } |
| 11: | } |
| 12: | } |
| 13: | return matrix C with the format of a set of chunks C |

Algorithm 1 may be better understood with reference to FIGS. 3 and 3a. FIG. 3 is a diagram illustrating an example execution plan 300 using a two-level chunking schema. FIG. 3a is a diagram illustrating an example of matrix multiplication using a two-level chunking schema. Matrix A (310) and Matrix B (320) are input by a sequential scan 330 of data in the super-chunks for A, and a sequential scan 340 of data in the super-chunks for B. Each column (311a-c) in Matrix A is matrix multiplied 350 on each row (321a-c) in Matrix B until all data points in the respective super-chunks have been processed. Matrix C is returned as output 360 as the result of a matrix multiply of Matrix A and Matrix B.

In the first loop, all super-chunks in matrix A are sequentially scanned from the row coordinate. In the second loop, the corresponding super-chunks in matrix B are sequentially scanned from the column coordinate. Because the size of the super-chunk (e.g., 311a) is typically less than the size of the matrix (e.g., 310), these operations iterate multiple times for each coordinate.

In the example shown in FIG. 3a, m=12, n=12, I=6, s=3, h=2 (number of chunk), and w=1. The three execution loops may be expressed as:

For(int i=0; i<12(3*2);i=i++)

for (int j=0; j<6/(3*2)j++)

for(int k=0;k<12/(3*1);k++)

To compute super-chunk 301, i=0, and the loop iterates for j, k. To compute super-chunk 302, i=1 and the loop iterates for j, k.

The following examples illustrate how chunk size, super-chunk size and super-chunk shape enhance I/O and processor performance. The first example shows the results of matrix multiplication using two-level chunking. The operations were executed using a Hewlett-Packard xw 8600 workstation with a 4-core, 2.00 Hz CPU and an entry-level NVIDIA GPU Quadro FX 570.

For matrix multiplication, the two input matrices (e.g., Matrix A and Matrix B) were square in shape, and the size of each dimension was selected as 2048. Matrix A was divided into different sizes of square chunks (e.g., 64×64, 128×128, 256×256, 512×512, 1024×1024 and 2048×2048), as shown across the top row in Tables 1 and 2, below. The chunks from Matrix A were combined with different size super-chunks (e.g., 1024×512) from Matrix B, as shown down the first column in Tables 1 and 2, below. Actual performance data for matrix multiplication operations is shown in Table 1 and in Table 2, below.

TABLE 1
Operator overhead over different chunk size and super-chunk size

| | Chunk Size | | | | | |
|---|---|---|---|---|---|---|
| Calc Time (s) | 64 × 64 | 128 × 128 | 256 × 256 | 512 × 512 | 1024 × 1024 | 2048 × 2048 |
| Super-Chunk Size | | | | | | |
| 2048 * 2048 | 0.000087 | 0.00008 | 0.000081 | 0.000081 | 0.00009 | 0.000078 |
| 2048 * 1024 | 0.000134 | 0.000119 | 0.00012 | 0.000119 | 0.000131 | |
| 1024 * 1024 | 0.00039 | 0.000419 | 0.000452 | 0.000442 | 0.00045 | |
| 1024 * 512 | 0.000767 | 0.000765 | 0.000722 | 0.001227 | | |
| 512 * 512 | 0.002862 | 0.003161 | 0.004451 | 0.003279 | | |
| 512 * 256 | 0.005119 | 0.004911 | 0.004557 | | | |
| 256 * 256 | 0.018703 | 0.021186 | 0.0212 | | | |
| 256 * 128 | 0.026066 | 0.02621 | | | | |
| 128 * 128 | 0.102926 | 0.105968 | | | | |
| 128 * 64 | 0.173513 | | | | | |
| 64 * 64 | 0.628434 | | | | | |

The results shown in Table I indicate that pairing the same size super-chunks in each Matrix (e.g., 64×64 in Matrix A with 64×64 in Matrix B) tended to increase performance. In addition, for the same super-chunk (e.g., reading across a row), the size of the chunk generally had little negative effect on operator performance.

TABLE 2
I/O overhead over different chunk size and super-chunk size

| | Chunk Size | | | | | |
|---|---|---|---|---|---|---|
| Data Move Time(s) | 64 × 64 | 128 × 128 | 256 × 256 | 512 × 512 | 1024 × 1024 | 2048 × 2048 |
| Super-Chunk Size | | | | | | |
| 2048 * 2048 | 0.335963 | 0.298613 | 0.290734 | 0.291738 | 0.286921 | 0.285553 |
| 2048 * 1024 | 0.332415 | 0.300937 | 0.287818 | 0.27683 | 0.241886 | |
| 1024 * 1024 | 0.417341 | 0.337728 | 0.334918 | 0.29925 | 0.230709 | |
| 1024 * 512 | 0.413833 | 0.328363 | 0.28386 | 0.187823 | | |
| 512 * 512 | 0.569821 | 0.435812 | 0.292576 | 0.291852 | | |
| 512 * 256 | 0.564889 | 0.377879 | 0.244009 | | | |
| 256 * 256 | 0.800189 | 0.521299 | 0.448634 | | | |
| 256 * 128 | 0.768927 | 0.500687 | | | | |
| 128 * 128 | 1.541204 | 0.99315 | | | | |
| 128 * 64 | 1.193246 | | | | | |
| 64 * 64 | 1.521432 | | | | | |

The results shown in Table 2 indicate that even very small tiling does not offer better 110 performance for frequent I/O access. The super-chunk is the basic computing unit in this system, and thus may be involved multiple times for aggregation (see, e.g., 350 in FIG. 3). If the size of the super-chunk is too small, this may result in frequent 110 access. But the size of the super-chunk is also constrained by size of the memory.

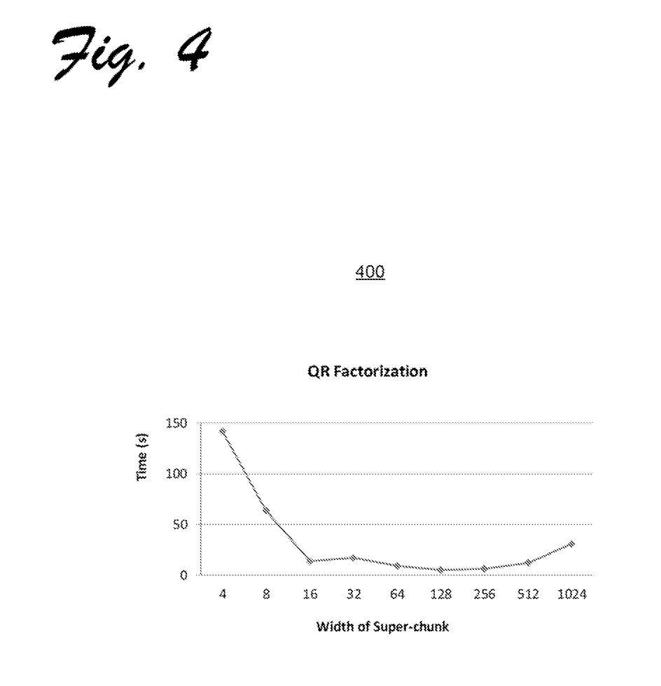

The second example shows the results of OR factorization using two-level chunking. In linear algebra, OR factorization of a matrix means decomposing the matrix into an orthogonal matrix Q and an upper triangular matrix R. QR factorization may be used, for example, to solve a linear least squares problem. Again, the operations were executed using a Hewlett-Packard xw8600 workstation with a 4-core, 2.00 Hz CPU and an entry-level NVIDIA GPU Quadro FX 570. In this example, a column-oriented super-chunk was used. Different column widths were selected, and the corresponding I/O performance was measured as a function of processing time. The results are shown in FIG. 4.

It is recognized that not all multidimensional arrays can be divided by a concrete value. For example, if matrix A includes thirteen items in each row, the matrix is not divisible by four. To address this issue, the data is still stored in one chunk, and empty values are used to fill the outer areas. If the size of one chunk is small (e.g., only 16K or 32K), these empty values do not consume much storage and thus is an acceptable solution,

it is also recognized is that not all arrays can be divided by the size of the super-chunk. Again, the same strategy may be adopted. The metadata table records all dimension information, and so this approach does not impact the final results or cause errors.

FIG. 4 is a plot 400 showing OR factorization with various width super-chunks. The column width is shown on the x-axis and I/O performance is shown on the y-axis. It can be seen in the plot 400 that increasing column width generally results in better I/O performance. The most significant increase in performance was observed by increasing the column width up to about 16. I/O performance did not increase significantly for column widths greater than 16. When considering the overall performance, however, the best I/O performance was observed for a column width of about 128.

Before continuing, it should be noted that two-level chunking for data analytics may be implemented in a database environment. The database(s) may include any content. There is no limit to the type or amount of content that may be used. In addition, the content may include unprocessed or “raw” data, or the content may undergo at least some level of processing.

The operations described herein may be implemented in a computer system configured to execute database program code. In an example, the program code may be implemented in machine-readable instructions (such as but not limited to, software or firmware). The machine-readable instructions may be stored on a non-transient computer readable medium and are executable by one or more processor to perform the operations described herein The program code executes the function of the architecture of machine readable instructions as self-contained modules. These modules can be integrated within a self-standing tool, or may be implemented as agents that run on top of an existing program code. However, the operations described herein are not limited to any specific implementation with any particular type of program code.

The examples described above are provided for purposes of illustration, and are not intended to be limiting. Other devices and/or device configurations may be utilized to carry out the operations described herein.

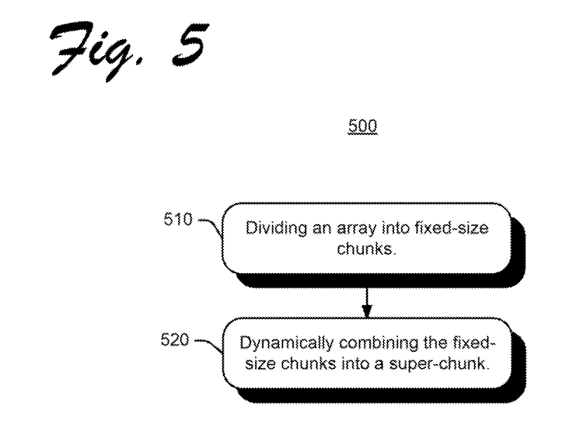

FIG. 5 is a flowchart illustrating example operations which may be implemented as two-level chunking for data analytics. Operations 500 may be embodied as logic instructions on one or more computer-readable medium. When executed on a processor, the logic instructions cause a general purpose computing device to be programmed as a special-purpose machine that implements the described operations, in an example, the components and connections depicted in the figures may be used.

Operation 510 includes dividing an array into fixed-size chunks. Operation 520 includes dynamically combining the fixed-size chunks into a super-chunk. A size of the super-chunk may be based on parameters of a subsequent operation. The size of the super-chunk may be determined at run time. For example, the chunk size may be selected to be between about 16K to 32K.

For purposes of illustration, the subsequent operation may be matrix multiplication. Matrix multiplication may include iterating over chunks to join matrix A and matrix B and outputting result matrix C, and using range selection queries for super-chunk A, super-chunk B. and super-chunk C. Matrix multiplication may also include breaking super-chunk C into a set of chunks; and returning matrix C having a format of the set of chunks.

It is noted that two-level chunking for data analytics is not limited to use with matrix multiplication. Two-level chunking for data analytics may be implemented with other statistical computing and execution workflows,

The operations shown and described herein are provided to illustrate example implementations. It is noted that the operations are not limited to the ordering shown, Still other operations may also be implemented.

Still further operations may include using range-selection queries for dynamically combining the fixed-size chunks into the super-chunk. Operations may include accessing each chunk with only one input/output (I/O) operation. Operations may also include dynamically combining fixed-size chunks into a super-chunk.

The operations may be implemented at least in part using an end-user interface (e.g., web-based interface). In an example, the end-user is able to make predetermined selections, and the operations described above are implemented on a back-end device to present results to a user. The user can then make further selections, It is also noted that various of the operations described herein may be automated or partially automated.

It is noted that the examples shown and described are provided for purposes of illustration and are not intended to be limiting. Still other examples are also contemplated.

1. A method of two-level chunking for data analytics, comprising:
dividing an array into fixed-size chunks; and
dynamically combining the fixed-size chunks into a super-chunk, wherein a size of the super-chunk is based on parameters of a subsequent operation.

2. The method of claim 1, further comprising using range-selection queries for dynamically combining the fixed-size chunks into the super-chunk,

3. The method of claim 1, further comprising determining the size of the super-chunk at run time.

4. The method of claim 1, further comprising accessing each chunk with only one input/output (I/O) operation.

5. The method of claim 1, further comprising selecting a chunk size based on physical block size.

6. The method of claim 1, wherein an underlying structure remains unchanged when selecting fixed-size chunks for combining into the super-chunk.

7. The method of claim 1, wherein the subsequent operation is matrix multiplication.

8. The method of claim 7, wherein matrix multiplication further comprises:
iterating over chunks to join matrix A and matrix B and outputting result matrix C; and
using range selection queries for super-chunk A, super-chunk B, and super-chunk C.

9. The method of claim 8, wherein matrix multiplication further comprises:
breaking super-chunk C into a set of chunks, and
returning matrix C having a format of the set of chunks.

10. A system of two-level chunking for data analytics, comprising:
a database; and
a query engine configured to:
divide an array in the database into fixed-size chunks; and
dynamically combine the fixed-size chunks into a super-chunk.

11. The system of claim 10, further comprising using range-selection queries for dynamically combining the fixed-size chunks into the super-chunk.

12. The system of claim 10, further comprising determining a size of the super-chunk at run time, wherein the size of the super-chunk is based on parameters of a subsequent operation

13. The system of claim 10. further comprising accessing each chunk with only one input/output (I/O) operation.

14. The system of claim 10, further comprising selecting a chunk size to match physical block size.

15. The system of claim 10, wherein an underlying structure remains unchanged when selecting fixed-size chunks for combining into the super-chunk.

16. The system of claim 10, wherein the subsequent operation is matrix multiplication.

17. The system of claim 16, wherein matrix multiplication further comprises:
iterating over chunks to join matrix A and matrix B and outputting result matrix C;
using range selection queries for super-chunk A, super-chunk B, and super-chunk C;
breaking super-chunk C into a set of chunks; and returning matrix C having a format of the set of chunks.

18. A two-level chunking system for data analytics, comprising:
means for dividing an array into fixed-size chunks;
means for combining the fixed-size chunks into a super-chunk: and
means for selecting a size of the super-chunk based on parameters of a subsequent operation.

19. The system of claim 18, wherein the means for combining further comprise range-selection queries.

20. The system of claim 18, wherein the means for selecting the size of the super-chunk further comprise means for determining the size at run time.
